(19) United States
(12) Patent Application Publication
(10) Pub. No.: US 2022/0389630 A1
(43) Pub. Date: Dec. 8, 2022

(54) METHOD FOR PRODUCING FIBER MOLDED BODY, FIBER MOLDED BODY, SOUND-ABSORBING MATERIAL, VEHICLE INTERIOR MATERIAL AND MICROFIBER

(71) Applicant: Mitsubishi Chemical Corporation, Tokyo (JP)

(72) Inventors: Masaki FUJIE, Tokyo (JP); Tatsuhiko INAGAKI, Tokyo (JP)

(73) Assignee: Mitsubishi Chemical Corporation, Tokyo (JP)

(21) Appl. No.: 17/819,788

(22) Filed: Aug. 15, 2022

Related U.S. Application Data
(63) Continuation of application No. PCT/JP2021/007418, filed on Feb. 26, 2021.

(30) Foreign Application Priority Data
Feb. 28, 2020 (JP) 2020-032744

(51) Int. Cl. D04H 1/4382; D04H 1/541; D01F 6/18; D04H 1/4282; D04H 1/4326; B60R 13/08

(52) U.S. Cl. CPC D04H 1/43835; D04H 1/5418; D01F 6/18; D04H 1/4282; D04H 1/4326; B60R 13/08; D10B 2505/12; D10B 2401/00

(57) ABSTRACT

There are provided microfibers that generate less formaldehyde and acetaldehyde and have a favorable fiber openness, a fiber molded body using the microfibers, and a method for producing the same. The method for producing a fiber molded body of the present invention is a method for producing a fiber molded body comprising molding of a fiber mixture, wherein the fiber mixture comprises microfibers, wherein the content of the microfibers in the fiber mixture is 5 mass % or more, wherein, in the microfibers, an amount of an oil adhered is 0.1 to 1 mass %, a total amount of ethylene oxide units and propylene oxide units generated is 0.01 to 0.5 mass %, and a single fiber fineness is 0.01 to 0.5 dtex.

This application is a continuation application of International Application No. PCT/JP2021/007418, filed on Feb. 26, 2021, which claims the benefit of priority of the prior Japanese Patent Application No. 2020-032744, filed Feb. 28, 2020, the content of which is incorporated herein by reference.

The present invention relates to a method for producing a fiber molded body, a fiber molded body, a sound-absorbing material, a vehicle interior material and a microfiber.

### BACKGROUND ART

Sound absorbing/sound insulation materials are used in a wide range of fields from vehicle parts used for railway vehicles, vehicles and the like, to electrical products such as vacuum cleaners.

For example, noise that is introduced into a cabin of a vehicle is divided into noise that is introduced when a sound generated from an engine passes through a vehicle body and noise that is introduced when noise generated when tires come into contact with a road surface passes through the vehicle body.

As a method for reducing such noise, there is a method using a sound insulation material that insulates against inflowing noise, a sound-absorbing material that absorbs inflowing noise, or a sound absorbing/sound insulation material having both sound absorption performance and sound insulation performance (hereinafter referred to as sound absorption/sound insulation performance).

Sound insulation means that the generated acoustic energy is reflected and blocked by a shield, and sound absorption means that the generated acoustic energy is converted into thermal energy while being transmitted along the internal path of the material, and disappears.

Improving sound absorption/sound insulation performance generally involves increasing the weight of the sound absorbing/sound insulation material, but recently, particularly in the field of vehicles, the need for improvement of fuel efficiency and resource saving has rapidly increased, and reducing the weight of sound absorbing/sound insulation materials has been strongly demanded.

In order to solve the issues of sound absorption/sound insulation performance and weight reduction, which are at odds, a material having excellent sound insulation for transmitted sound and efficient sound absorption of noise inflowing from other transmission paths (windows, etc.), in other words, a material having excellent balance of sound absorbing/sound insulation, is required.

For example, in a vehicle, the transmitted sound from a dash compartment of an engine sound, which accounts for 50% or more of in-vehicle noise, mainly has a frequency of about 100 to 1,000 Hz, and it is required to efficiently perform absorption/insulation of sound in this region.

For example, Patent Literature 1 proposes a technology in which, when fibers having a single fiber fineness of 0.01 to 0.5 dtex are used as a sound-absorbing material, the average value of the vertically incident sound absorption coefficient for sounds having frequencies of 200 to 1,000 Hz is set to 40% or more, and absorption/insulation of sounds at 1,000 Hz or less is efficiently performed.

On the other hand, fibers used for sound absorbing/sound insulation materials for vehicles may have problems with the generation of formaldehyde and acetaldehyde, which are harmful to the human body, due to solvents that are mainly used in the production process, and volatile organic substances contained in the finishing agent.

As an example of synthetic fibers having a small amount of volatile organic components, Patent Literature 2 proposes acrylic fibers obtained using an inorganic solvent or acrylic fibers obtained by treating acrylic fibers with hot water at 80° C. or higher.

In addition, Patent Literature 3 proposes a technology in which synthetic fibers are opened and laminated, exposed to hot air at 150 to 210° C., washed with water and dried to remove organic volatile components, and thereby volatile organic components harmful to the human body are reduced in amount.

### CITATION LIST

### Patent Literature

[Patent Literature 1]
PCT International Publication No. WO 2018/021319

[Patent Literature 2]
Japanese Unexamined Patent Application, First Publication No. 2002-327332

[Patent Literature 3]
Japanese Unexamined Patent Application, First Publication No. 2005-240214

### SUMMARY OF INVENTION

### Technical Problem

However, in Patent Literature 1, the problem of volatile organic substances is not considered.

The methods described in Patent Literature 2 and 3 have problems that a special processing treatment is required to remove volatile organic substances, which is time-consuming and costly, and the fiber openness is reduced due to the processing treatment.

An object of the present invention is to provide microfibers that generate less formaldehyde and acetaldehyde and have a favorable fiber openness, a fiber molded body using the microfibers, and a method for producing the same, and a sound-absorbing material and a vehicle interior material using the microfibers.

### Solution to Problem

The present invention includes the following aspects.
[1] A method for producing a fiber molded body, comprising molding of a fiber mixture,
   wherein the fiber mixture comprises microfibers,
   wherein the content of the microfibers in the fiber mixture is 5 mass % or more, and
   wherein, in the microfibers, an amount of an oil adhered is 0.1 to 1 mass %, a total content of ethylene oxide units and propylene oxide units is 0.01 to 0.5 mass %, and a single fiber fineness is 0.01 to 0.5 dtex.
[2] The method for producing a fiber molded body according to [1],
   wherein the ethylene oxide units and the propylene oxide units are comprised in the oil.
[3] The method for producing a fiber molded body according to [1] or [2],
   wherein a total content of ethylene oxide units and propylene oxide units in the fiber molded body is 0.01 to 0.5 mass %.
[4] The method for producing a fiber molded body according to any one of [1] to [3],
   wherein a total content of ethylene oxide units and propylene oxide units contained in fibers other than the microfibers in the fiber mixture is less than 0.01 mass %.
[5] A fiber molded body comprising microfibers,
   wherein the content of the microfibers in the fiber molded body is 5 mass % or more, and
   wherein, in the microfibers, an amount of an oil adhered is 0.1 to 1 mass %, a total content of ethylene oxide units and propylene oxide units is 0.01 to 0.5 mass %, and a single fiber fineness is 0.01 to 0.5 dtex.
[6] The fiber molded body according to [5],
   wherein the content of the microfibers in the fiber molded body is 70 mass % or less.
[7] The fiber molded body according to [5] or [6],
   wherein a total content of ethylene oxide units and propylene oxide units in the fiber molded body is 0.01 to 0.5 mass %.
[8] The fiber molded body according to any one of [5] to [7],
   wherein the fiber molded body comprises chemical fibers other than the microfibers,
   wherein the single fiber fineness of the chemical fibers is 1 to 10 dtex, and
   wherein the content of the chemical fibers in the fiber molded body is 10 to 60 mass %.
[9] The fiber molded body according to [8],
   wherein a total content of ethylene oxide units and propylene oxide units in the chemical fibers is less than 0.001 mass %.
[10] The fiber molded body according to [8] or [9],
   wherein the chemical fibers are polyester fibers.
[11] The fiber molded body according to any one of [5] to [10],
   wherein the basis weight is 200 to 3,000 g/m², and the thickness is 10 to 50 mm.
[12] The fiber molded body according to any one of [5] to [11],
   wherein the fiber molded body is a non-woven fabric, paper, or a filling material.
[13] The fiber molded body according to any one of [5] to [12],
   wherein the microfibers are acrylic fibers.
[14] The fiber molded body according to any one of [5] to [13],
   wherein the fiber length of the microfibers is 3 to 60 mm.
[15] The fiber molded body according to any one of [5] to [14],
   wherein the amount of generated formaldehyde measured by a Tedlar bag measurement method is 1 μg/8 g or less.
[16] The fiber molded body according to any one of [5] to [15],
   wherein the amount of generated acetaldehyde measured by a Tedlar bag measurement method is 2 μg/8 g or less.
[17] A sound-absorbing material containing a fiber material,
   wherein the fiber material comprises the fiber molded body according to any one of [5]to [16], and
   wherein the content of the fiber molded body according to any one of [5]to [16] in the fiber material is 30 mass % or more.
[18] A vehicle interior material containing a fiber material,
   wherein the fiber material contains the fiber molded body according to any one of [5]to [16], and
   wherein the content of the fiber molded body according to any one of [5]to [16] in the fiber material is 30 mass % or more.
[19] A microfiber in which an amount of an oil adhered is 0.1 to 1 mass %, a total content of ethylene oxide units and propylene oxide units is 0.01 to 0.5 mass %, and a single fiber fineness is 0.01 to 0.5 dtex.

### Advantageous Effects of Invention

According to the present invention, it is possible to provide microfibers that generate less formaldehyde and acetaldehyde and have a favorable fiber openness, a fiber molded body using the microfibers, and a method for producing the same, and a sound-absorbing material and a vehicle interior material using the microfibers.

### DESCRIPTION OF EMBODIMENTS

### Microfiber

The microfiber of the present invention (hereinafter referred to as a “microfiber (x)”) has an amount of an oil adhered of 0.1 to 1 mass %, a total content of 0.01 to 0.5 mass % of ethylene oxide units and propylene oxide units, and has a single fiber fineness of 0.01 to 0.5 dtex.

An oil is adhered to the microfiber (x), and the oil contains a plurality of components such as a softening agent, an antistatic agent, a high-speed spinning agent, and a smoothing agent in order to improve the process passability of the fiber spinning process and the yarn spinning process. The oil adhered to the microfiber (x) contains one or both of an ethylene oxide unit and a propylene oxide unit. The ethylene oxide unit and the propylene oxide unit are contained in a cleaning agent, a fiber processing agent, a fiber finishing agent and the like used in the fiber producing process.

The amount of an oil adhered is the extraction amount that is extracted by a method according to the Soxhlet extraction method to be described below.

In order to obtain an effect of improving the process passability, 0.1 mass % or more of an oil is adhered to the microfiber (x). In addition, the amount of an oil adhered is 1 mass % or less in order to prevent adhesion between the microfibers and prevent the microfiber from being wound on rollers.

The amount of an oil adhered to the microfiber (x) is 0.1 to 1 mass %, more preferably 0.15 to 0.8 mass %, and still more preferably 0.2 to 0.6 mass %.

The ethylene oxide (EO) unit and the propylene oxide (PO) unit in the microfiber (x) function as a high-speed spinning agent and a smoothing agent during fiber spinning and during yarn spinning, and contribute to the fiber processing stability. From this viewpoint, a total content of the ethylene oxide units and the propylene oxide units in the microfiber (x) (hereinafter referred to as an “EO/PO content”) is 0.01 mass %, preferably 0.05 mass % or more, and more preferably 0.10 mass % or more.

On the other hand, if the EO/PO content is not too large, aggregation between microfibers and adhesion to the device when the microfibers are processed are unlikely to occur. In addition, the inventors conducted extensive studies, and as a result, found that ethylene oxide and/or propylene oxide in microfibers causes the generation of acetaldehyde and formaldehyde. From these viewpoints, the EO/PO content in the microfiber (x) is 0.5 mass % or less, preferably 0.4 mass % or less, and more preferably 0.35 mass % or less. When the EO/PO content in the microfiber (x) is set to 0.5 mass % or less, the amount of acetaldehyde and formaldehyde generated can be reduced to the standard value determined by each vehicle manufacturer or less.

The above upper limits and lower limits can be arbitrarily combined. For example, the EO/PO content in the microfiber (x) is 0.01 to 0.5 mass %, preferably 0.05 to 0.4 mass %, and more preferably 0.10 to 0.35 mass %.

It is conceivable that acetaldehyde and formaldehyde are generated in the drying process of the microfiber (x), during molding of a fiber molded body, and during heating when acetaldehyde and formaldehyde are measured.

In this specification, the EO/PO content in the fibers is an BO/PO content obtained by analyzing compounds adhered to the fibers, measuring its structural formula and the amount adhered, and determining a total content of the ethylene oxide units (—(CH₂)₂−O−) and the propylene oxide units (—(CH₂)₃—O—).

The single fiber fineness of the microfibers (x) is 0.01 to 0.5 dtex.

If the single fiber fineness is 0.01 dtex or more, the handling of microfibers during production of a fiber molded body is favorable, and the production cost does not become too high. The single fiber fineness is preferably 0.05 dtex or more, and more preferably 0.1 dtex or more. If the single fiber fineness is 0.5 dtex or less, favorable sound absorption/sound insulation performance can be obtained. The single fiber fineness is preferably 0.4 dtex or less, and more preferably 0.3 dtex or less.

The above upper limits and lower limits can be arbitrarily combined. For example, the single fiber fineness of the microfibers (x) is 0.01 to 0.5 dtex, preferably 0.05 to 0.4 dtex, and more preferably 0.1 to 0.3 dtex.

For the microfiber (x), the amount of generated formaldehyde measured by a Tedlar bag measurement method is preferably 1 μg/8 g or less.

If the amount of formaldehyde generated from the microfiber (x) is 1 μg/8 g or less, the influence on the human body can be sufficiently reduced. The amount is more preferably 0.8 μg/8 g or less, and still more preferably 0.648 g or less.

For the microfiber (x), the amount of generated acetaldehyde measured by the Tedlar bag measurement method is preferably 2 μg/8 g or less.

If the amount of acetaldehyde generated from the microfiber (x) is 2 μg/8 g or less, the influence on the human body can be sufficiently reduced. The amount is more preferably 1 μg/8 g or less and still more preferably 0.8 μg/8 g or less.

### Method for Producing Microfiber

Hereinafter, a microfiber (x) producing method will be described using an acrylic fiber (xa) as an example.

The acrylic fiber (xa) is composed of an acrylic polymer obtained by copolymerizing acrylonitrile and unsaturated monomers that can be polymerized therewith. As the unsaturated monomers, for example, acrylic acid, methacrylic acid, or alkyl esters thereof, vinyl acetate, acrylamide, vinyl chloride, vinylidene chloride, and depending on the purpose, ionic unsaturated monomers such as sodium vinylbenzene sulfonate, sodium methallylsulfonate, sodium allylsulfonate, sodium acrylamide methyl propane sulfonate, and sodium parasulfophenyl metallyl ether can be used.

The content of the acrylonitrile unit among all units in the acrylic polymer is preferably 80 mass % or more, and more preferably 85 mass % or more. In addition, the upper limit is preferably 99 mass % or less.

The unsaturated monomers may be used alone or two or more thereof may be used in combination.

In addition, the acrylic polymers constituting the acrylic fiber (xa) may be used alone or two or more thereof may be used in combination. For example, a mixture containing two or more types of acrylic polymers having different acrylonitrile contents may be used.

As a polymerization method for producing acrylic polymers, for example, suspension polymerization or solution polymerization can be selected, but the method is not particularly limited.

The molecular weight of the acrylic polymer may be a molecular weight in any range in which it is generally used when acrylic fibers are produced, and is not particularly limited. When a 0.5 mass % dimethylformamide solution is used, it is preferable to perform adjustment so that the reduced viscosity at 25° C. is in a range of 1.5 to 3.0.

As a method for producing an acrylic fiber (xa) using an acrylic polymer as a raw material, a wet fiber spinning method can be used.

In the wet fiber spinning method, first, a fiber spinning stock solution containing an acrylic polymer is discharged from a plurality of discharge holes into a coagulation bath to obtain a coagulated yarn.

The fiber spinning stock solution is prepared by dissolving an acrylic polymer in a solvent so that the concentration is 15 to 28 mass %. When the concentration of the acrylic polymer is 15 mass % or more, the difference between the shape of the nozzle hole and the shape of the fiber cross section does not become large during coagulation, and it is easy to obtain a desired shape of the cross section. When the concentration is 28 mass % or less, the stability of the fiber spinning stock solution over time is improved, and the fiber spinning stability is improved.

As the solvent, for example, in addition to organic solvents such as dimethylformamide, dimethylacetamide, and dimethyl sulfoxide, nitric acid, a rodanate aqueous solution, and a zinc chloride aqueous solution can be used. When the shape of the cross section is controlled so that it is closer to the shape of the nozzle hole, an organic solvent is beneficially used.

In order to maintain a favorable fiber spinning state, spinning and withdrawing may be performed so that the fiber spinning draft which is a value defined by the value obtained by dividing a take-up speed of the coagulated yarn by the discharge line speed of the fiber spinning stock solution is in a range of 0.7 to 3.0. If the fiber spinning draft is 0.7 or more, the difference between the shape of the nozzle hole and the shape of the fiber cross section is small during coagulation, it is easy to obtain a desired shape of the cross section, and the cross section unevenness is reduced. If the fiber spinning draft is 3.0 or less, there is little yarn breakage in the coagulation bath liquid, and it is easy to obtain the fiber itself.

The obtained coagulated yarn is stretched, washed, and dried according to known methods and known conditions, and cut to a predetermined length according to applications to obtain raw cotton. The obtained raw cotton is opened, and used for producing, for example, a fiber bundle, a spun yarn, and a non-woven fabric.

In the drying process, it is preferable to adhere an oil to the washed fiber and dry it. As the oil, an oil composition known in the production of acrylic fibers can be used. Drying can be performed by, for example, a method of bringing it into contact with a heating roller. After the drying process, crimping may be imparted by a known method.

For example, since fibers used for a sound-absorbing material or a vehicle interior material are not washed or dyed when they are processed into the sound-absorbing material or the vehicle interior material, the oil adhered in the processing process is adhered without change.

When the oil contains a surfactant having one or both of an ethylene oxide unit and a propylene oxide unit, the EO/PO content in the microfiber (x) can be adjusted by adjusting oil adhesion conditions. For example, the EO/PO content in the microfiber (x) can be reduced by a method of reducing the amount of an oil adhered to the fiber, a method of reducing the concentration of the surfactant in the oil, or a method of combining these.

Therefore, it is possible to obtain the microfiber (x) that generates less formaldehyde and acetaldehyde, which are harmful to the human body, without providing a special processing treatment process.

Here, when an oil containing a surfactant having an ethylene oxide unit and/or a propylene oxide unit is adhered to fibers before drying, for example, the EO/PO content in the microfiber (x) can also be adjusted by a hot air treatment or a washing treatment during fiber processing, in addition to a method of adjusting an amount of an oil adhered to obtain a microfiber (x).

A method for producing a fiber molded body of the present invention (hereinafter referred to as a fiber molded body (X)) is a method for producing a fiber molded body including molding of a fiber mixture, the fiber mixture contains microfibers, the content of the microfibers in the fiber mixture is 5 mass % or more, and in the microfibers, the amount of an oil adhered is 0.1 to 1 mass %, the BO/PO content is 0.01 to 0.5 mass %, and the single fiber fineness is 0.01 to 0.5 dtex.

If the amount of an oil adhered to the microfiber (x) is 0.1 mass % or more, it is easy to prevent the occurrence of static electricity, and it is easy to improve the fiber openness from the fiber bundle. If the amount is 1 mass % or less, since an effect of preventing adhesion between fibers is easily obtained, the process passability for producing the fiber molded body (X) is improved.

The amount of an oil adhered to the microfiber (x) is preferably 0.15 mass % or more and more preferably 0.2 mass % or more. In addition, the amount is preferably 0.9 mass % or less and more preferably 0.8 mass % or less.

These upper limits and lower limits can be arbitrarily combined. For example, the amount of an oil adhered to the microfiber (x) is 0.1 to 1 mass %, preferably 0.15 to 0.9 mass %, and more preferably 0.2 to 0.8 mass %.

In the method for producing a fiber molded body of the present invention, it is preferable that the ethylene oxide unit and the propylene oxide unit be contained in the oil adhered to the microfiber.

The ethylene oxide unit and the propylene oxide unit are contained, for example, as an oil component of a high-speed spinning agent and a smoothing agent.

In the method for producing a fiber molded body of the present invention, the EO/PO content in the fiber molded body is preferably 0.01 to 0.5 mass %.

If the EO/PO content in the fiber molded body (X) is 0.01 mass % or more, the fiber openness of the fiber when the fiber molded body (X) is formed tends to be improved. If the EO/PO content is 0.5 mass % or less, the amount of acetaldehyde and formaldehyde generated can be reduced. The EO/PO content in the fiber molded body (X) is more preferably 0.05 mass % or more and still more preferably 0.10 mass % or more. In addition, the EO/PO content is more preferably 0.45 mass % or less and still more preferably 0.40 mass % or less.

The above upper limits and lower limits can be arbitrarily combined. For example, the EO/PO content in the fiber molded body (X) is 0.01 to 0.5 mass %, preferably 0.05 to 0.45 mass %, and more preferably 0.10 to 0.40 mass %.

In the method for producing a fiber molded body of the present invention, the content of ethylene oxide units and propylene oxide units contained in fibers other than the microfibers (x) is preferably less than 0.01 mass %. In particular, fibers contained in the fiber mixture other than the microfibers preferably have an EO/PO content of less than 0.01 mass %.

If the EO/PO content of the fibers other than the microfibers is less than 0.01 mass %, the amount of acetaldehyde and formaldehyde generated from the fiber molded body (X) can be reduced.

In the method for producing a fiber molded body of the present invention, the content of the microfibers in the fiber mixture is preferably 5 mass % or more. The fiber mixture is preferably a mixture containing microfibers (x) and fibers other than the microfibers (x) or may be a mixture in which these are laminated.

If the content of the microfibers (x) is 5 mass % or more, the sound absorption/sound insulation performance tends to be improved, and the mass of the fiber molded body (X) required for the same sound absorption/sound insulation performance to be exhibited can be reduced. From these viewpoints, the content of the microfibers (x) in the fiber molded body (X) is 5 mass % or more, preferably 10 mass % or more, and more preferably 20 mass % or more.

The content of the microfibers (x) in the fiber mixture is preferably 70 mass % or less, more preferably 50 mass % or less, and still more preferably 40 mass % or less from the viewpoint of uniformity of the mixture.

The above upper limits and lower limits can be arbitrarily combined. For example, the content of the microfibers in the fiber mixture is preferably 5 to 70 mass %, more preferably 10 to 50 mass %, and still more preferably 20 to 40 mass %.

### Fiber Molded Body

The fiber molded body of the present invention contains 5 mass % or more of microfibers having an amount of an oil adhered of 0.1 to 1 mass %, an EO/PO content of 0.01 to 0.5 mass %, and a single fiber fineness of 0.01 to 0.5 dtex.

The fiber molded body of the present invention contains microfibers (x). When the fiber molded body (X) is constructed using the microfibers (x), it is possible to obtain a fiber molded body (X) in which the amount of generated formaldehyde and acetaldehyde, which are harmful to the human body, is reduced. The microfibers (x) contained in the fiber molded body (X) may be used alone or two or more thereof may be used in combination.

The content of the microfibers (x) in the fiber molded body (X) is 5 mass % or more. If the content of the microfibers (x) is 5 mass % or more, the sound absorption/sound insulation performance tends to be improved, and the mass of the fiber molded body (X) required for the same sound absorption/sound insulation performance to be exhibited can be reduced.

From these viewpoints, the content of the microfibers (x) in the fiber molded body (X) is 5 mass % or more, preferably 10 mass % or more, and still more preferably 20 mass % or more. The content may be 100 mass %.

When microfibers (x) having an amount of an oil adhered of 0.1 mass % or more are contained in the fiber molded body (X), it is easy to reduce the occurrence of static electricity of the fiber molded body (X). The amount of an oil adhered to the microfiber (x) is preferably 0.15 mass % or more and more preferably 0.2 mass % or more. If the amount of an oil adhered to the microfiber (x) is 1 mass % or less, since the EO/PO content is reduced, it is easy to reduce the amount of generated acetaldehyde and formaldehyde, which are harmful to the human body, and it is possible to reduce the odor of the oil. The amount of an oil adhered to the microfiber (x) is preferably 0.9 mass % or less and more preferably 0.8 mass % or less.

The above upper limits and lower limits can be arbitrarily combined. For example, the amount of an oil adhered to the microfiber (x) is 0.1 to 1 mass %, preferably 0.15 to 0.9 mass %, and more preferably 0.2 to 0.8 mass %.

If the EO/PO content in the microfiber (x) contained in the fiber molded body (X) is 0.01 mass % or more, the fiber openness of the fibers when the fiber molded body (X) is formed tends to be improved. If the EO/PO content is 0.5 mass % or less, it is possible to reduce the amount of acetaldehyde and formaldehyde generated in the fiber molded body (X). The EO/PO content in the fiber molded body (X) is more preferably 0.05 mass % or more and more preferably 0.10 mass % or more. In addition, the EO/PO content is more preferably 0.45 mass % or less and still more preferably 0.40 mass % or less.

The above upper limits and lower limits can be arbitrarily combined. For example, the EO/PO content in the fiber molded body (X) is 0.01 to 0.5 mass %, preferably 0.05 to 0.45 mass %, and more preferably 0.10 to 0.40 mass %.

In the fiber molded body (X), a smaller content of the ethylene oxide units and a smaller content of the propylene oxide units are more preferable.

If the single fiber fineness of the microfibers (x) contained in the fiber molded body (X) is 0.01 dtex or more, it is easy to maintain the shape of the fiber molded body (X). If the single fiber fineness is 0.5 dtex or less, favorable sound absorption/sound insulation performance can be obtained.

The single fiber fineness of the microfibers (x) is 0.01 to 0.5 dtex, preferably 0.05 to 0.4 dtex, and more preferably 0.1 to 0.3 dtex.

The content of the microfibers (x) in the fiber molded body (X) is preferably 70 mass % or less. If the content of the microfibers (x) in the fiber molded body (X) is 70 mass % or less, it is easy to reduce the amount of generated formaldehyde and acetaldehyde, which are harmful to the human body, from the fiber molded body (X). In addition, the fiber molded body (X) can contain binder fibers and recycled fibers other than the microfibers (x), and the shape of the fiber molded body (X) can be stabilized so that the fiber molded body does not become too soft, and it is easy to reduce the cost. The content of the microfibers (x) in the fiber molded body (X) is more preferably 50 mass % or less and still more preferably 40 mass % or less.

The EO/PO content in the fiber molded body (X) is preferably 0.01 to 0.5 mass %.

When the EO/PO content with respect to the total mass of the fiber molded body (X) is set to 0.5 mass % or less, the amount of acetaldehyde and formaldehyde generated can be reduced to the standard value determined by each vehicle manufacturer or less. The EO/PO content in the fiber molded body (X) is more preferably 0.4 mass % or less and still more preferably 0.35 mass % or less.

The lower limit of the EO/PO content in the fiber molded body (X) is not particularly limited. For example, the lower limit is preferably 0.01 mass % or more, more preferably 0.02 mass % or more, still more preferably 0.03 mass % or more, and particularly preferably 0.04 mass % or more.

The above upper limits and lower limits can be arbitrarily combined. For example, the EO/PO content in the fiber molded body (X) is preferably 0.01 to 0.5 mass %, more preferably 0.02 to 0.5 mass %, still more preferably 0.03 to 0.4 mass %, and particularly preferably 0.04 to 0.35 mass %.

The fiber molded body (X) may contain one or more types of fibers other than the microfibers (x). The other fibers may be fibers having an EO/PO content of less than 0.01 mass % or fibers having an EO/PO content of more than 0.5 mass %.

The content of other fibers in the fiber molded body (X) is preferably set so that the EO/PO content in the fiber molded body (X) is within the above preferable range.

The content of the microfibers (x) in the fiber molded body (X) is preferably 5 to 70 mass %, more preferably 10 to 60 mass %, and still more preferably 20 to 40 mass % so that it is easy to reduce the amount of formaldehyde and acetaldehyde generated and the sound absorption/sound insulation performance tends to be improved.

When the fiber molded body (X) of the present invention contains fibers other than the microfibers (x), the other fibers are preferably chemical fibers having a single fiber fineness of 1 to 10 dtex other than the microfibers (x) and the content of other fibers in the fiber molded body (X) is 10 to 60 mass %.

Examples of chemical fibers include synthetic fibers such as nylon fibers, polyester fibers, acrylic fibers, polypropylene fibers, and polyethylene fibers, semi-synthetic fibers such as acetate fibers, and regenerated fibers such as rayon and cupra.

If the single fiber fineness of the chemical fibers contained in the fiber molded body (X) other than the microfibers (x) is 1 dtex or more, the shape of the fiber molded body (X) tends to be stable. If the single fiber fineness is 10 dtex or less, the sound absorption/sound insulation performance is unlikely to deteriorate.

From these viewpoints, the single fiber fineness of the chemical fibers contained in the fiber molded body (X) other than the microfibers (x) is preferably 1 to 10 dtex, more preferably 2 to 7 dtex, and still more preferably 3 to 5 dtex.

In addition, if the content of the chemical fibers contained in the fiber molded body (X) other than the microfibers (x) in the fiber molded body (X) is 10 mass % or more, the shape of the fiber molded body (X) tends to be stable. If the content of the chemical fibers contained in the fiber molded body (X) other than the microfibers (x) is 60 mass % or less, the sound absorption/sound insulation performance is unlikely to deteriorate.

From these viewpoints, the content of the chemical fibers contained in the fiber molded body (X) other than the microfibers (x) in the fiber molded body (X) is preferably 10 to 60 mass %, more preferably 15 to 50 mass %, and still more preferably 20 to 40 mass %.

The EO/PO content of the chemical fibers contained in the fiber molded body (X) other than the microfibers (x) is preferably less than 0.001 mass % and more preferably 0 mass % so that the amount of formaldehyde and acetaldehyde generated from the fiber molded body is reduced.

The chemical fibers contained in the fiber molded body (X) other than the microfibers (x) are preferably polyester fibers because the strength of the fiber molded body is improved and the shape of the fiber molded body tends to be stable.

Examples of the fiber molded body (X) include a non-woven fabric, paper, and a filling material. Some of the fibers constituting the fiber molded body (X) may be fixed to each other. The fiber molded body (X) can be produced by a known molding method using the microfibers (x).

Preferably, the fiber molded body (X) has a basis weight of 200 to 3,000 g/m² and a thickness of 10 to 50 mm.

If the basis weight of the fiber molded body (X) is 200 g/m² or more, the sound absorption/sound insulation performance tends to be improved. If the basis weight is 3,000 g/m² or less, it is easy to reduce the weight.

From these viewpoints, the basis weight of the fiber molded body (X) is preferably 200 to 3,000 g/m², more preferably 400 to 2,500 g/m², and still more preferably 600 to 2,000 g/m².

If the thickness of the fiber molded body (X) is 10 mm or more, the sound absorption/sound insulation performance tends to be improved. If the thickness is 50 mm or less, it is easy to reduce the weight.

From these viewpoints, the thickness of the fiber molded body (X) is preferably 10 to 50 mm, more preferably 15 to 40 mm, and still more preferably 25 to 35 mm.

Since the fiber molded body (X) has excellent sound absorption/sound insulation performance and is lightweight, for example, it can be suitably used for preventing in-vehicle noise in a vehicle.

The material of the microfiber (x) is not particularly limited. As the microfibers (x), for example, synthetic fibers such as acrylic fibers, polyester fibers, and nylon fibers, and semi-synthetic fibers such as acetate and promix can be suitably used.

Particularly, in order to reduce the weight, acrylic fibers and nylon fibers having a small specific gravity can be used more suitably, and in consideration of the sound absorption property and productivity of fineness fibers, acrylic fibers can be used more suitably.

The fiber length of the microfiber (x) is preferably 3 to 60 mm.

If the fiber length of the microfibers (x) is 3 to 60 mm, the dispersibility of the fibers is improved, the fiber molded body (X) is easily molded, and it is easy to maintain the shape of the fiber molded body (X). The fiber length of the microfibers (x) is more preferably 15 to 40 mm, and more preferably 20 to 35 mm.

Preferably, the microfiber (x) has a number of crimps of 8 to 14/25 mm and a crimping ratio of 5 to 9%.

If the number of crimps is 8 to 14/25 mm and the crimping ratio is 5 to 9%, the moldability when the fiber molded body (X) is formed is improved and it is easy to maintain the shape of the fiber molded body.

Since an acrylic fiber (hereinafter referred to as an acrylic fiber (xa)), which is the microfiber (x), has a favorable sound absorption property for sounds having frequencies of 200 to 1,000 Hz, it can be suitably used as a sound-absorbing material.

In particular, according to sound absorption at 200 to 1,000 Hz, road noise, engine sounds and the like can be removed so that the material can be suitably used as an interior material for vehicles.

In the fiber molded body (X), the amount of formaldehyde generated from the fiber molded body (X) measured by the Tedlar bag measurement method is preferably 1 μg/8 g or less.

If the amount of formaldehyde generated from the fiber molded body (X) is 1 μg/8 g or less, the influence on the human body can be sufficiently reduced. The amount is preferably 0.848 g and more preferably 0.6 μg/8 g.

In the fiber molded body (X), the amount of acetaldehyde generated from the fiber molded body (X) measured by the Tedlar bag measurement method is preferably 2 μg/8 g or less.

If the amount of acetaldehyde generated from the fiber molded body (X) is 2 μg/8 g, the influence on the human body can be sufficiently reduced. The amount is more preferably 1 μg/8 g and more preferably 0.8 μg/8 g.

Preferably, the fiber molded body (X) contains thermally fused fibers, and some of the fibers constituting the fiber molded body (X) are thermally fused and fixed. Since the fibers are fixed to each other, even if the fiber molded body (X) has a complicated shape, the shape can be maintained.

The thermally fused fibers in this specification are fibers that melt at a temperature lower than the melting temperature of general molten fibers such as polyester. Specific examples of thermally fused fibers include low-melting-point polyesters, polyethylenes, polypropylenes, cores/sheaths of these fibers, and composite fibers such as side-by-side type fibers.

The single fiber fineness of the thermally fused fibers is preferably 1 to 5 dtex. If the single fiber fineness of the thermally fused fibers is 1 dtex or more, it is easy to fix the fibers constituting the fiber molded body (X) to each other. If the single fiber fineness is 5 dtex or less, it is easy to minimize a decrease in the sound absorption coefficient.

From these viewpoints, the single fiber fineness of the thermally fused fibers is preferably 1 to 5 dtex, and more preferably 1.5 to 3 dtex.

When the fiber molded body (X) contains thermally fused fibers, the content of the thermally fused fibers in the fiber molded body (X) is preferably 10 to 50 mass %.

If the content of the thermally fused fibers is 10 mass % or more, it is easy to maintain the shape of the fiber molded body (X). If the content of the thermally fused fibers is 50 mass % or less, functions of fibers other than the thermally fused fibers are likely to be sufficiently exhibited. For example, favorable sound absorption/sound insulation performance can be easily obtained.

From these viewpoints, the content of the thermally fused fibers in the fiber molded body (X) is more preferably 15 to 45 mass % and still more preferably 20 to 40 mass %.

### Sound Absorbing Material

The microfiber (x) is suitably used for a sound-absorbing material.

The sound-absorbing material of the present invention is a sound-absorbing material containing a fiber material, and preferably a sound-absorbing material composed of a fiber material, and contains the fiber molded body (X) as a fiber material, and the content of the fiber molded body (X) in the fiber material is 30 mass % or more.

The sound-absorbing material of the present invention has at least sound absorption performance, and includes a sound absorbing/sound insulation material having both sound absorption performance and sound insulation performance.

The content of the microfibers (x) in the sound-absorbing material is preferably 5 to 70 mass %, more preferably 10 to 60 mass %, and still more preferably 20 to 40 mass % so that it is easy to reduce the amount of formaldehyde and acetaldehyde generated and the sound absorption performance tends to be improved.

It is preferable that the microfibers (x) in the sound-absorbing material include acrylic fibers (xa). Particularly, the sound-absorbing material containing acrylic fibers (xa) has an excellent sound absorption property for sounds having frequencies of 200 to 1,000 Hz. The sound-absorbing material having an excellent sound absorption property for sounds at 200 to 1,000 Hz has excellent performance of removing road noise, engine sounds and the like and thus is suitable as an interior material for vehicles.

The content of the acrylic fibers (xa) in the microfibers (x) contained in the sound-absorbing material is preferably 5 to 100 mass % and more preferably 10 to 100 mass %.

A preferable form of the sound-absorbing material of the present invention is the same as the preferable form of the fiber molded body (X). A sound-absorbing material may be formed by combining two or more type of fiber molded bodies (X).

In particular, among the fiber molded bodies (X), a non-woven fabric, paper, and a multi-layer structure thereof are suitable as the sound-absorbing material.

### Vehicle Interior Material

The microfiber (x) is suitable as a vehicle interior material.

The vehicle interior material of the present invention is a vehicle interior material containing a fiber material and preferably a vehicle interior material composed of a fiber material, and includes the fiber molded body (X) as a fiber material, and the content of the fiber molded body (X) in the fiber material is 30 mass % or more.

The content of the microfibers (x) in the vehicle interior material is preferably 5 to 70 mass %, more preferably 10 to 60 mass %, and still more preferably 20 to 40 mass % so that it is easy to reduce the amount of formaldehyde and acetaldehyde generated, the sound absorption performance tends to be improved, and functions of a heat retention material can be also exhibited.

It is preferable that the microfibers (x) in the vehicle interior material include acrylic fibers (xa). When the acrylic fibers (xa) are contained, particularly, a sound absorption property for sounds having frequencies of 200 to 1,000 Hz is excellent. When the sound absorption property for a sound at 200 to 1,000 Hz is excellent, the performance of removing road noise, engine sounds and the like is excellent.

The content of the acrylic fibers (xa) in the microfibers (x) contained in the vehicle interior material is preferably 5 to 100 mass % and more preferably 10 to 100 mass %.

A preferable form of the vehicle interior material of the present invention is the same as the preferable form of the fiber molded body (X). A vehicle interior material may be formed by combining two or more types of fiber molded bodies (X).

In particular, among the fiber molded bodies (X), a non-woven fabric, paper, and a multi-layer structure thereof are suitable as the vehicle interior material.

### EXAMPLES

Hereinafter, the present invention will be described in more detail with reference to examples. Here, the measurement of respective items in examples was based on the following method.

### Method of Measuring Single Fiber Fineness

Measurement was performed using auto vibro-type fineness measuring instrument (Denior Computer DC-11 commercially available from Search Control Electric Co., Ltd.) under conditions of a temperature of 25° C. and a humidity of 65%. The measurement was performed 25 times, and the average value was used.

### Method of Measuring Amount of Oil Adhered

Measurement was performed according to a methanol extraction method of JIS L1015 (2010) 8.22(c). Main measurement conditions were as follows. The amount of an acrylic fiber sample was about 5 g, drying conditions for the sample before extraction were drying at 105±2° C. for 45 minutes, the time for which heating was performed so that the extraction liquid was kept weakly boiling was 65 minutes, and drying conditions after extraction were drying at 105±2° C. for 45 minutes.

Amount of an oil adhered (mass %)=((W1-W2))/W2×100 W1 was the mass (g) of the sample before extraction, W2 was the mass (g) of the sample after extraction, and the average value of results of two times was used as the amount of an oil adhered.

### Method of Measuring Number of Crimps and Crimping Ratio

Measurement was performed according to JIS L1015 (2010) 8.12.

### Method of Measuring Amount of Formaldehyde and Acetaldehyde Generated

The amount of formaldehyde and acetaldehyde generated by a Tedlar bag method was measured by a known method.

An operation of filling a 10 L Tedlar bag with pure nitrogen gas and removing the filled pure nitrogen gas was repeated twice. Then, 8 g of a measurement sample was put into the Tedlar bag and 4 L of pure nitrogen gas was sealed therein. Then, the Tedlar bag was heated at 65° C. for 2 hours. A collecting tube (InertSep mini AERO DNPH) was attached, and 2 L of the gas was sucked at a flow rate of 1.0 L/min using a pump (SP208). The sampled gas was measured by a GC/MS method, and the amount of formaldehyde and acetaldehyde generated was calculated.

### Evaluation of Fiber Openness

The fiber openness was visually evaluated.

After fiber spinning, the raw cotton cut to 28 mm was passed through a fiber opener. When sufficiently opened fibers were visually observed, the fiber openness was evaluated as A, when some defective openings were observed, the fiber openness was evaluated as B, and when the number of defective openings was large, the fiber openness was evaluated as C.

Sufficient opening means that fibers were separated one by one, and defective opening means that fibers were often bundled together.

### Example 1

A copolymer composed of 93 mass % of acrylonitrile units and 7 mass % of vinyl acetate units was obtained by aqueous suspension polymerization. The reduced viscosity of this copolymer in the 0.5 mass % dimethylformamide solution at 25° C. was 2.0.

This copolymer was dissolved in dimethylacetamide to obtain a fiber spinning stock solution having a copolymer concentration of 24 mass %. The fiber spinning stock solution was spun into a 50% dimethylacetamide aqueous solution at 40° C. from the discharge hole of the fiber spinning nozzle.

In addition, the sample was stretched to 5 times its length with hot water at 95° C. and washed, an oil was applied and then it was dried with a drying roller, and mechanical crimping was additionally performed to obtain microfibers having a number of crimps of 10/25 mm, a crimping ratio of 7%, and a single fiber fineness of 0.1 dtex.

Table 1 shows the EO/PO content in the obtained microfibers, the amount of formaldehyde generated, the amount of acetaldehyde generated, and the evaluation result of the fiber openness. (Examples 2 to 5 and Comparative Examples 1 to 3)

Microfibers were obtained in the same manner as in Example 1 except that the amount of an oil applied in the producing process was changed to adjust the EO/PO content in the microfibers.

Table 1 shows the EO/PO content in the obtained microfibers, the amount of formaldehyde generated, the amount of acetaldehyde generated, and the evaluation result of the fiber openness.

### Example 7: Production of Non-Woven Fabric

50 mass % of microfibers cut to 38 mm and produced in the same manner as in Example 1, 30 mass % of thermally fused polyester short fibers having a single fiber fineness of 2.2 dtex, a fiber length of 50 mm, and an EO/PO content of less than 0.001 mass %, and 20 mass % of acrylic short fibers having a single fiber fineness of 3.3 dtex, a fiber length of 50 mm, and EO/PO content of 0.15 mass % were mixed to obtain a non-woven fabric having a basis weight of 1,200 g/m² and a thickness of 30 mm.

Table 1 shows the EO/PO content in the obtained non-woven fabric, the amount of formaldehyde generated, and the amount of acetaldehyde generated.

### Example 8: production of non-woven fabric

30 mass % of microfibers cut to 38 mm and produced in the same manner as in Example 1, 30 mass % of thermally fused polyester short fibers having a single fiber fineness of 4.4 dtex, a fiber length of 50 mm, and an EO/PO content of less than 0.001 mass %, and 40 mass % of hollow conjugated polyester fibers having a single fiber fineness of 7.0 dtex, a fiber length of 50 mm, and an EO/PO content of less than 0.001 mass % were mixed to obtain a non-woven fabric having a basis weight of 900 g/m² and a thickness of 30 mm.

Table 1 shows the EO/PO content in the obtained non-woven fabric, the amount of formaldehyde generated, and the amount of acetaldehyde generated.

TABLE 1

| | | | Amount of | Amount of | | |
|---|---|---|---|---|---|---|
| | | EO/PO | formaldehyde | acetaldehyde | | Amount of |
| | | content | generated | generated | Fiber | oil adhered |
| | Form | [mass %] | [μg/8 g] | [μg/8 g] | openness | [mass %] |
| Example 1 | Fiber | 0.13 | 0.5 | 0.37 | A | 0.26 |
| Example 2 | Fiber | 0.29 | 0.36 | 0.4 | A | 0.59 |
| Example 3 | Fiber | 0.31 | 0.26 | 0.6 | A | 0.65 |
| Example 4 | Fiber | 0.19 | 0.25 | 0.6 | A | 0.40 |
| Example 5 | Fiber | 0.17 | 0.1 | 0.29 | A | 0.35 |
| Comparative | Fiber | 0.005 | 0.07 | 0.05 | B | 0.01 |
| Example 1 | | | | | | |
| Comparative | Fiber | 0.58 | 1.1 | 2.67 | B | 1.20 |
| Example 2 | | | | | | |
| Comparative | Fiber | 0.96 | 2.02 | 5.13 | B | 1.98 |
| Example 3 | | | | | | |
| Example 6 | Non-woven | 0.15 | 0.43 | 0.73 | — | — |
| | fabric | | | | | |
| Example 7 | Non-woven | 0.05 | 0.78 | 1.8 | — | — |
| | fabric | | | | | |

As shown in the results of Table 1, in the fibers of Examples 1 to 5 in which the EO/PO content was in a range of 0.01 to 0.5 mass %, the amount of formaldehyde generated from the fibers in Tedlar bag method was 1 μg/8 g or less, the amount of acetaldehyde generated was 2 μg/8 g or less, and the fiber openness was also good.

In addition, in the non-woven fabrics of Examples 7 and 8 in which the EO/PO content was in a range of 0.01 to 0.5 mass %, the amount of formaldehyde generated from the non-woven fabric in the Tedlar bag method was 1 μg/8 g or less, and the amount of acetaldehyde generated was 2 μg/8 g or less.

On the other hand, in the fibers of Comparative Examples 2 and 3 in which the EO/PO content was larger than 0.5 mass %, the amount of formaldehyde and acetaldehyde generated from the fibers in the Tedlar bag method was large.

In addition, based on the results of Comparative Examples 1 to 3, it can be understood that, if the EO/PO content is too large or too low, the fiber openness tends to decrease.

1. A method for producing a fiber molded body, comprising molding of a fiber mixture,
wherein the fiber mixture comprises microfibers,
wherein the content of the microfibers in the fiber mixture is 5 mass % or more, and
wherein, in the microfibers, an amount of an oil adhered is 0.1 to 1 mass %, a total content of ethylene oxide units and propylene oxide units is 0.01 to 0.5 mass %, and a single fiber fineness is 0.01 to 0.5 dtex.

2. The method for producing a fiber molded body according to claim 1,
wherein the ethylene oxide units and the propylene oxide units are comprised in the oil.

3. The method for producing a fiber molded body according to claim 1,
wherein a total content of ethylene oxide units and propylene oxide units in the fiber molded body is 0.01 to 0.5 mass %.

4. The method for producing a fiber molded body according to claim 1,
wherein a total content of ethylene oxide units and propylene oxide units contained in fibers other than the microfibers in the fiber mixture is less than 0.01 mass %.

5. A fiber molded body comprising microfibers,
wherein the content of the microfibers in the fiber molded body is 5 mass % or more, and
wherein, in the microfibers, an amount of an oil adhered is 0.1 to 1 mass %, a total content of ethylene oxide units and propylene oxide units is 0.01 to 0.5 mass %, and a single fiber fineness is 0.01 to 0.5 dtex.

6. The fiber molded body according to claim 5,
wherein the content of the microfibers in the fiber molded body is 70 mass % or less.

7. The fiber molded body according to claim 5,
wherein a total content of ethylene oxide units and propylene oxide units in the fiber molded body is 0.01 to 0.5 mass %.

8. The fiber molded body according to claim 5,
wherein the fiber molded body comprises chemical fibers other than the microfibers,
wherein the single fiber fineness of the chemical fibers is 1 to 10 dtex, and
wherein the content of the chemical fibers in the fiber molded body is 10 to 60 mass %.

9. The fiber molded body according to claim 8,
wherein a total content of ethylene oxide units and propylene oxide units in the chemical fibers is less than 0.001 mass %.

10. The fiber molded body according to claim 8,
wherein the chemical fibers are polyester fibers.

11. The fiber molded body according to claim 5,
wherein the basis weight is 200 to 3,000 g/m², and the thickness is 10 to 50 mm.

12. The fiber molded body according to claim 5,
wherein the fiber molded body is a non-woven fabric, paper, or a filling material.

13. The fiber molded body according to claim 5,
wherein the microfibers are acrylic fibers.

14. The fiber molded body according to claim 5,
wherein the fiber length of the microfibers is 3 to 60 mm.

15. The fiber molded body according to claim 5,
wherein the amount of generated formaldehyde measured by a Tedlar bag measurement method is 1 μg/8 g or less.

16. The fiber molded body according to claim 5,
wherein the amount of generated acetaldehyde measured by a Tedlar bag measurement method is 2 μg/8 g or less.

17. A sound-absorbing material containing a fiber material,
wherein the fiber material comprises the fiber molded body according to claim 5, and
wherein the content of the fiber molded body according to claim 5 in the fiber material is 30 mass % or more.

18. A vehicle interior material containing a fiber material,
wherein the fiber material contains the fiber molded body according to claim 5, and
wherein the content of the fiber molded body according to claim 5 in the fiber material is 30 mass % or more.

19. A microfiber in which an amount of an oil adhered is 0.1 to 1 mass %, a total content of ethylene oxide units and propylene oxide units is 0.01 to 0.5 mass %, and a single fiber fineness is 0.01 to 0.5 dtex.
